(19) United States
(12) Patent Application Publication
(10) Pub. No.: US 2024/0169255 A1
(43) Pub. Date: May 23, 2024

(54) SYSTEMS AND METHODS FOR INTEGRATING DISPARATE FEATURE GROUPS DURING FEATURE ENGINEERING OF TRAINING DATA FOR ARTIFICIAL INTELLIGENCE MODELS

(71) Applicant: Capital One Services, LLC, McLean, VA (US)

(72) Inventors: Muralikumar VENKATASUBRAMANIAM, Plano, TX (US); Enwang ZHOU, Plano, TX (US); Fei TONG, Allen, TX (US)

(73) Assignee: Capital One Services, LLC, McLean, VA (US)

(21) Appl. No.: 18/056,494

(22) Filed: Nov. 17, 2022

(51) Int. Cl. G06N 20/00; G06F 16/2455

(52) U.S. Cl. CPC G06N 20/00; G06F 16/2455

(57) ABSTRACT

Methods and systems for generating, storing, and modifying data for feature engineering purposes. In particular, methods and systems for automatically generating feature engineering pipelines by chaining multiple transformers (models and/or function trained to transform data in specific ways) and estimators (e.g., algorithms trained with input data to generate transformers) in a sequential order based on feature attributes. To determine the specific transformers and estimators, the system may access a shared knowledge database, graph engine, and pipeline engine.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence often relies on large amounts of high-quality data. The process for obtaining this data and ensuring it is high-quality is often complex and time-consuming. Second, even if this training data exists, the training data must be properly formatted, which is also a complex and time-consuming process.

### SUMMARY

Methods and systems are described herein for novel uses and/or improvements to generating, training, and formatting data for artificial intelligence applications. As one example, methods and systems are described herein for generating, storing, and modifying data for feature engineering purposes. Feature engineering is the process of using domain knowledge to extract features (characteristics, properties, attributes, etc.) from raw data. By extracting these features, the system may improve the quality of results from a machine learning process as compared with supplying only the raw data to the machine learning process.

Traditionally, data scientists need to determine the data flow and manually code every step in a feature engineering pipeline. The development is time consuming and error prone if the feature engineering is complex, and the pipeline is large. Furthermore, as each machine learning application is different, the features needed, and the feature engineering pipeline to generate those features, is unique. As such, each new machine learning application typically starts with a feature engineering pipeline development project. The added burden of developing this feature engineering pipeline presents an additional technical challenge for artificial intelligence applications.

To overcome these technical deficiencies in feature engineering, methods and systems disclosed herein for automatically generating feature engineering pipelines by chaining multiple transformers (models and/or function trained to transform data in specific ways) and estimators (e.g., algorithms trained with input data to generate transformers) in a sequential order based on feature attributes. To determine the specific transformers and estimators, the system may access a shared knowledge database, graph engine, and pipeline engine.

The knowledge database may represent data and/or metadata on previously developed features and/or feature lineages (e.g., how each feature is built, such as the data sources and transformation used to generate the feature). The knowledge database may include archived information related to potential feature uses and/or applications. This information may include particular transformers, estimators, and/or arrangements thereof (e.g., feature lineages).

The graph engine generates feature graphs based on configurations of features and/or feature lineages, including the list of required features for given applications. The graph engine may extract feature metadata, feature lineages, source features, and/or other information used to represent the relationship among features. The graph engine may further rely on a knowledge graph in which the edges represent feature dependencies like source and target, and the nodes represent data transformations like transformers or estimators. The system may also record feature groups, which are entities used to group the features that do not have transformation. After the extraction, a feature lineage graph is generated with all required information to build an executable pipeline.

The pipeline engine may then sort entities (e.g., features, feature lineages, and/or feature groups) in the feature graph into a sequential order using a topological sorting algorithm. The pipeline engine may use desired features and/or other criteria to generate a pipeline for the feature engineering process. The pipeline engine may read the sequential feature lineages and convert them to transformation objects based on accessible machine learning libraries, after which the feature lineages may be chained into the pipeline. Once chained into the pipeline, the features, feature lineages, feature groups, and/or other information related thereto may be subjected to one or more operations (e.g., searching, filtering, modifying, etc.).

For example, the system may receive a request to determine whether specific features are present in a given feature group, whether particular transformations appear in a given feature lineage, etc. By doing so, the system may determine whether given features and/or feature lineages are used (and/or the transformers and estimators used) in order to automate the feature engineering process by reusing specific feature lineages, including the transformers and estimators therein.

In some aspects, systems and methods are disclosed for generating integrated feature graphs during feature engineering of training data for artificial intelligence models. For example, the system may receive, via a user interface, a user request to generate an integrated structure for an integrated feature graph for a feature engineering pipeline management system, wherein the integrated structure defines integrated feature lineages in the integrated feature graph. The system may then retrieve, from a feature engineering knowledge database, a first structure, wherein the first structure defines a first feature lineage. The system may retrieve, from the feature engineering knowledge database, a second structure, wherein the second structure defines a second feature lineage. The system may generate the integrated structure based on the first structure and the second structure, wherein the integrated structure includes a structure node shared by the first structure and the second structure. The system may receive, via the user interface, a user selection of the structure node. The system may, in response to the user selection of the structure node, generate for display, on the user interface, native data for the first structure or the second structure, and feature transformer data that describes, in a human-readable format, a transformation of the native data at the structure node.

Once the integrated feature graph is created, the system may be used to achieve additional technical benefits. For example, in conventional systems, the feature engineering pipeline management system needs to train the pipeline estimators to generate specifications and convert these estimators to transformers. When data scientists test different feature sets to train the models, the feature engineering pipeline needs to run from the beginning to the end even when only one feature is modified, added, and/or removed. This approach is not efficient especially since the same feature transformations are repeated for the unmodified features.

However, through the use of the integrated feature graph and the feature transformer data, the system may eliminate the repeated work by copying the repeated transformations, deleting the removed transformations, and/or only training the new or modified features. For example, once the integrated feature graph is created, the transformation lineage for a feature may be calculated by tracing the dependencies with a topological sorting algorithm. By doing so, the system may compare old feature lineages, as well as any new feature lineages created by a modification. Based on the comparison, the system may detect any differences in the two lineages (e.g., orders of the transformations, sources of lineages, target of lineages, and/or transformations in lineages, etc.). If any differences are detected, the system may determine where to combine the new lineage within the integrated feature graph by determining a structure node is shared by a first structure (e.g., a new lineage) and a second structure (e.g., an old/pre-existing lineage). The system may then merge the first structure and the second structure at the second structure node to generate an updated integrated structure in an efficient manner.

In some aspects, systems and methods are disclosed for integrating disparate feature groups during feature engineering of training data for artificial intelligence models. For example, the system may receive, via a user interface, a user request for a first modification for an integrated structure for an integrated feature graph for a feature engineering pipeline management system, wherein the integrated structure defines integrated feature lineages in the integrated feature graph. The system may determine a first structure node in the integrated structure corresponding to the first modification. The system may determine a first structure that corresponds to the first structure node, wherein the first structure defines a first feature lineage. The system may determine a second structure node in the integrated structure, wherein the second structure node is shared by the first structure and a second structure, wherein the second structure defines a second feature lineage. The system may generate an updated first structure based on the first modification. The system may merge the updated first structure and the second structure at the second structure node to generate an updated integrated structure. The system may, in response to generating an updated integrated structure, generate for display, on the user interface, a notification corresponding to the updated integrated structure.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for an integrated feature graph, in accordance with one or more embodiments.

FIG. 2 shows an illustrative diagram for integrating disparate feature groups during feature engineering, in accordance with one or more embodiments.

FIG. 3 shows illustrative components for using integrated feature graphs, in accordance with one or more embodiments.

FIG. 4 shows illustrative pseudocode for integrated feature graphs, in accordance with one or more embodiments.

FIG. 5 shows a flowchart of the steps involved in generating integrated feature graphs, in accordance with one or more embodiments.

FIG. 6 shows a flowchart of the steps involved in integrating disparate feature groups during feature engineering, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art, that the embodiments of the invention may be practiced without these specific details or with an equivalent arrangement. In other cases, well-known structures and devices are shown in block diagram form in order to avoid unnecessarily obscuring the embodiments of the invention.

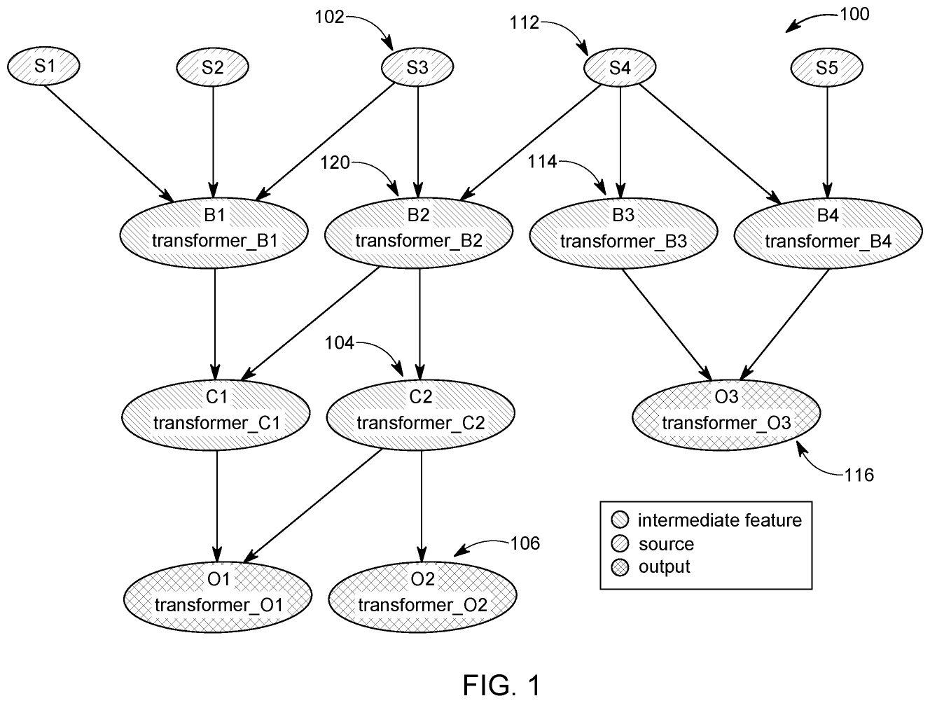

FIG. 1 shows an illustrative diagram for an integrated feature graph, in accordance with one or more embodiments. For example, FIG. 1 shows graph 100. Graph 100 may comprise an integrated feature graph for a feature engineering pipeline management system. The integrated structure may define an integrated feature lineage for the integrated feature graph for a feature engineering pipeline management system. For example, graph 100 may comprise a plurality of types of data structures or data models. One such data structure is a hierarchical data structure. A hierarchical database structure may comprise a data model in which the data is organized into a tree-like structure. The data may be stored as records which are connected to one another through links. A record is a collection of fields, with each field containing only one value. The type of record defines which fields the record contains. For example, in the hierarchical database structure, each child record has only one parent, whereas each parent record can have one or more child records.

Each record may act as a node. In some cases, the node may be a structure node. For example, the structure node (e.g., structure node 102) may be a basic unit of a data structure, such as a link between one or more structures. Each structure node may contain data and also may link to other nodes. For example, the integrated structure may be represented by a linear data structure of nodes and edges (e.g., a structure graph). In some embodiments, the system may implement links between nodes through pointers. Additionally, a structure node may be a node shared by one or more structures (e.g., a point of feature transformer data of a first structure and a second structure).

As described herein, “a structure node” may comprise a basic data structure which contains data (e.g., feature transformer data) and one or more links to other nodes. For example, the structure nodes may be used to represent a tree structure or a linked list. In structure, native data may progress from one structure node to another structure node. At each structure node, the native data may be subject to one or more transformers (e.g., as defined feature transformer data) corresponding to that structure node.

Graph 100 may represent an integrated data structure. As described herein, an “integrated data structure” may comprise a first data structure for a first feature lineage or first feature group and a second feature lineage for a second feature group. In some embodiments, the first data structure may comprise a data organization, management, and storage format that enables efficient access and modification for a second feature group. For example, the first data structure may include a collection of data values, nodes, edges, data fields, the relationships among them, and the functions or operations that can be applied to the data. The first structure may define a first feature lineage for the second feature group.

For example, FIG. 1 includes a first feature lineage as defined by a first source node (e.g., node 102), a first transformer node (e.g., node 104), and a first output node (e.g., node 106). FIG. 1 also includes a second feature lineage as defined by a second source node (e.g., node 112), a second transformer node (e.g., node 114), and a second output node (e.g., node 116). Furthermore, FIG. 1 includes a shared node (e.g., node 120). The shared node is shared by the first feature lineage and the second feature lineage, as the shared node is dependent on data transformations that occur at node 102 and node 112.

For example, once the integrated feature graph (e.g., graph 100) is created, the transformation lineage for a feature may be calculated by tracing the dependencies with topological sorting algorithm. These dependencies comprise the feature lineage for each feature, which corresponds to the output node. Each output node may comprise a given feature. Furthermore, each feature may be organized into one or more feature groups.

The system may then receive requests for particular features, feature groups, and/or data (e.g., feature transformer data) corresponding to a feature. As one example, the system may receive a search request (e.g., for a feature) and generate one or more responses based on the presence (or lack thereof) of particular features, feature groups, and/or data (e.g., feature transformer data) corresponding to a feature within the integrated feature graph. The system may also perform validations and/or issue spotting for particular features, feature groups, feature lineages, and/or data (e.g., feature transformer data) corresponding to a feature in order to determine whether existing trained data may be reused.

For example, the system may comprise a feature engineering pipeline management system. The feature engineering pipeline management system may monitor the status of one or more feature engineering projects (e.g., based on one or more datasets and/or knowledge databases). Each project may comprise selected and transformed variables created using a predictive machine learning or statistical model. Each project may comprise feature creation, feature transformation, feature extraction, and/or feature selection.

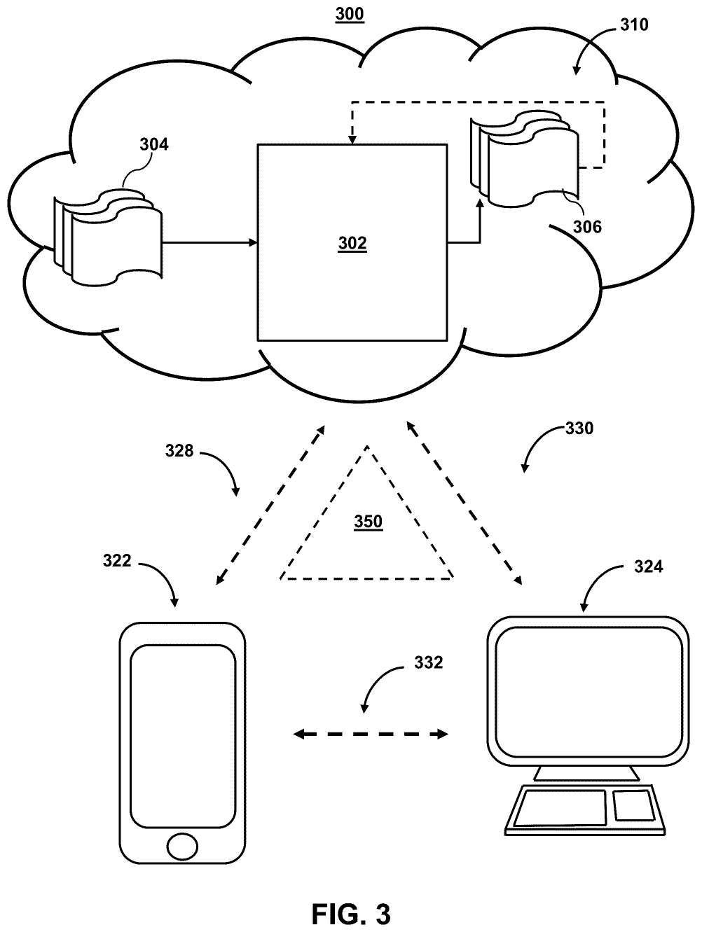

For example, feature creation may comprise creating new features (e.g., an output node such as node 106) from existing data to generate better predictions. In some embodiments, the system (e.g., model 302 (FIG. 3) below) may use feature creation techniques include: one-hot-encoding, binning, splitting, and calculated features. In another example, feature transformation and imputation may comprise replacing missing features or features that are not valid. The system (e.g., model 302 (FIG. 3) below) may use techniques that include: forming Cartesian products of features, non-linear transformations (such as binning numeric variables into categories), and/or creating domain-specific features. In yet another example, feature extraction may involve reducing the amount of data to be processed using dimensionality reduction techniques. The system (e.g., model 302 (FIG. 3) below) may use techniques include: Principal Component Analysis (PCA) and Linear Discriminant Analysis (LDA), which reduces the amount of memory and computing power required, while still accurately maintaining original data characteristics. In yet another example, feature selection may involve selecting subset of extracted features. The system (e.g., model 302 (FIG. 3) below) may use this to minimizing the error rate of a trained model as feature importance score and correlation matrix may be factors in selecting the most relevant features for model training.

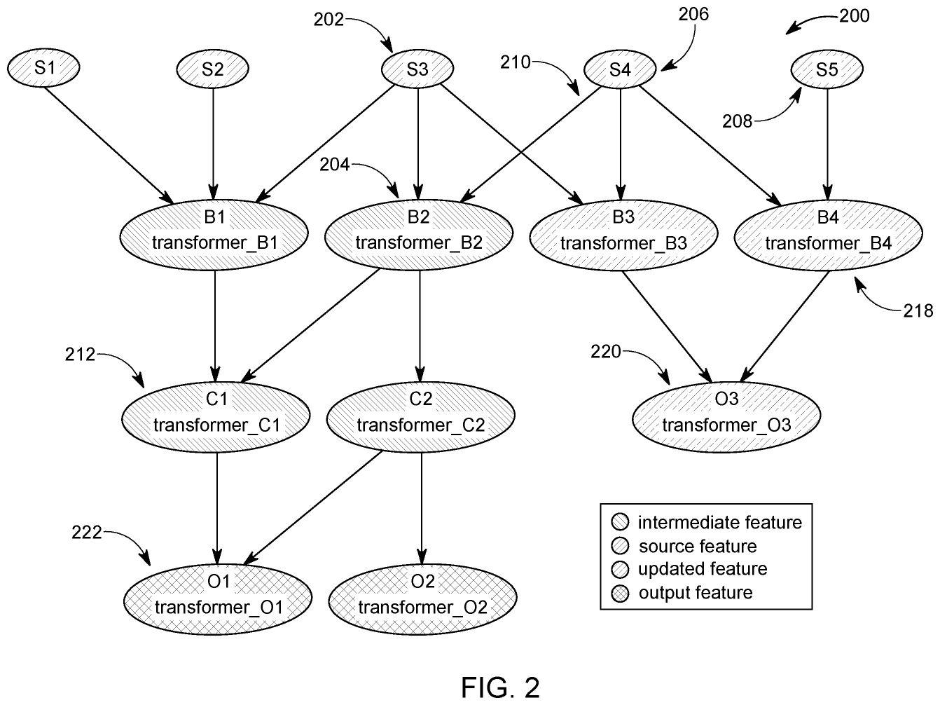

FIG. 2 shows an illustrative diagram for integrating disparate feature groups during feature engineering, in accordance with one or more embodiments. For example, using a feature graph (e.g., graph 100 (FIG. 1)), the system may determine dependencies in feature lineages. By doing so, the system may compare old feature lineages, as well as any new feature lineages created by a modification. Based on the comparison, the system may detect any differences in the two lineages (e.g., orders of the transformations, sources of lineages, target of lineages, and/or transformations in lineages, etc.). If there are any differences detected, the system may determine where to combine the new lineage within the integrated feature graph by determining a structure node is shared by a first structure (e.g., a new lineage) and a second structure (e.g., an old/pre-existing lineage). The system may then merge the first structure and the second structure at the second structure node to generate an updated integrated structure in an efficient manner.

For example, after an integrated feature graph is trained, a new pipeline (e.g., lineage) for a feature may be created based on an existing pipeline (e.g., lineage). As there is no untrained estimator in the existing pipeline, a new pipeline may be generated with all trained estimators. By doing so, only necessary training tasks (e.g., training tasks involving new structure nodes, new data transformations, and/or new lineages) are executed. The system avoids re-training the repeated transformations and thus maximizing efficiency.

For example, FIG. 2 shows graph 200. Graph 200 includes an updated node (e.g., node 208). The updated node may comprise a new node, a node that includes a modification to its feature transformer data, etc. As shown in graph 200, a feature lineage corresponding to the updated node includes node 218 and node 220. Without graph 200, the system would need to re-train all feature transformer data for all nodes in graph 200. However, using graph 200, the system may limit the re-training (or new training of) feature transformer data to just nodes 208, 218, and/or 220 because the other nodes in graph 200 do not share a lineage with node 208.

In contrast, if node 206 was updated, the system may determine other dependencies and/or shared nodes that would require updating. For example, node 206 and node 202 include a shared node (e.g., node 204) in their respective lineages (e.g., based on edge 210). In order to minimize the amount of re-training of the nodes in graph 200, the system may determine any shared connections between a lineage for node 206 and node 202. The system may then re-train effected lineages and merge the lineages at the shared node.

FIG. 3 shows illustrative components for using integrated feature graphs, in accordance with one or more embodiments. For example, FIG. 3 may show illustrative components for generating integrated feature graphs during feature engineering of training data for artificial intelligence models. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., notifications).

In some embodiments, the control circuitry may comprise a graph engine and/or a pipeline engine. The graph engine may generate feature graphs based on configurations of features and/or feature lineages, including the list of required features for given applications. The graph engine may extract feature metadata, feature lineages, source features, and/or other information used to represent the relationship among features. The graph engine may further rely on a knowledge graph in which the edges represent feature dependencies like source and target, and the nodes represent data transformations like transformers or estimators. The system may also record feature groups, which are entities used to group the features that do not have transformation. After the extraction, a feature lineage graph is generated with all required information to build an executable pipeline.

The pipeline engine may then sort entities (e.g., features, feature lineages, and/or feature groups) in the feature graph into a sequential order using a topological sorting algorithm. The pipeline engine may use desired features and/or other criteria to generate a pipeline for the feature engineering process. The pipeline engine may read the sequential feature lineages and convert them to transformation objects based on accessible machine learning libraries, after which the feature lineages may be chained into the pipeline. Once chained into the pipeline, the features, feature lineages, feature groups, and/or other information related thereto may be subjected to one or more operations (e.g., searching, filtering, modifying, etc.).

As referred to herein, a “user interface” may comprise a human-computer interaction and communication in a device, and may include display screens, keyboards, a mouse, and the appearance of a desktop. For example, a user interface may comprise a way a user interacts with an application or a website. A notification may comprise any content.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

For example, each of these devices may comprise a knowledge database that represents data and/or metadata on previously developed features and/or feature lineages (e.g., how each feature is built, such as the data sources and transformation used to generate the feature). The knowledge database may include archived information related to potential feature uses and/or applications. This information may include particular transformers, estimators, and/or arrangements thereof (e.g., feature lineages). For example, the knowledge database may comprise a knowledge graph that uses a graph-structured data model or topology to integrate data. Knowledge graphs may represent a feature graph and store interlinked descriptions of entities—feature, feature transformer data, feature lineages, and/or feature groups—while also encoding the semantics underlying the used terminology.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred to collectively herein as “models”). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a data transformation, estimator for a transformer, normalization of an input value, a regression model prediction, etc.).

In some embodiments, model 302 may be used for feature engineering by selecting, manipulating, and transforming raw data into features that can be used in supervised learning. For example, model 302 may create new features (or refine/modify) existing features in order to improve a feature set (e.g., make the feature set better for input into another model). Model 302 may use supervised and/or unsupervised learning and may train itself to simplify and/or speed up data transformations while also enhancing model accuracy. In some embodiments, model 302 may train itself to generate better feature transformations at one or more nodes. A feature transformation may comprise a function that transforms features from one representation to another. In some embodiments, model 302 may train itself to generate better feature extraction at one or more nodes. Feature extraction is the process of extracting features from a data set to identify useful information. In some embodiments, model 302 may train itself to perform better exploratory data analysis at one or more nodes.

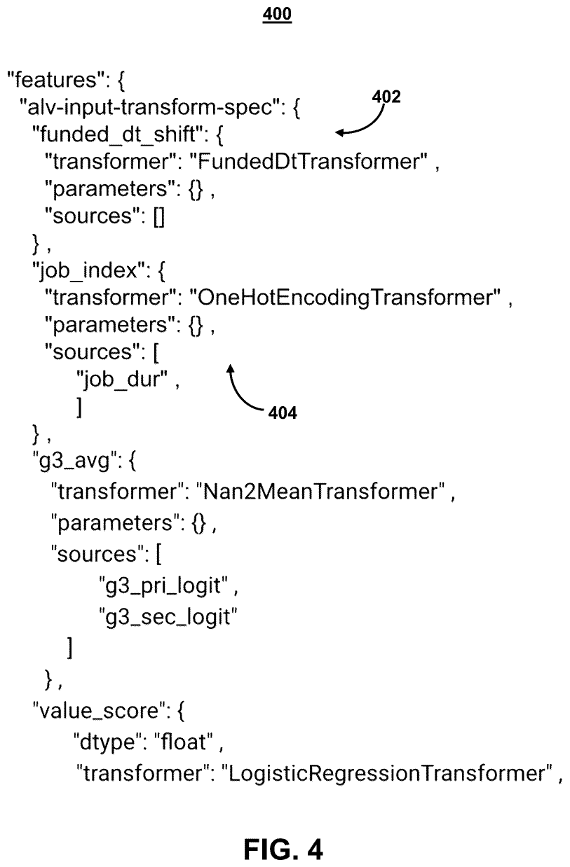

In some embodiments, the values, parameters, and/or other data corresponding to the feature transformer data (e.g., as described in FIG. 4) may be selected and/or generated as an output of model 302. For example, as described above, feature engineering (and/or training a model therefor) may comprise selecting and transforming variables when creating a predictive model using machine learning or statistical modeling. In particular, the system may generate feature transformation data that optimizes the feature creation, feature transformation, feature extraction, and feature selection. With deep learning, the feature engineering is automated as part of the algorithm learning. For example, model 302 may generate new feature (e.g., corresponding to an output node (e.g., node 106 (FIG. 1))). Additionally or alternatively, model 302 may generate (or select features for) feature groups.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., a data transformation, estimator for a transformer, normalization of an input value, a regression model prediction, etc.).

In some embodiments, the model (e.g., model 302) may automatically perform actions based on outputs 306. In some embodiments, the model (e.g., model 302) may not perform any actions. The output of the model (e.g., model 302) may be used to a shared structure node, a feature lineage, a notification, etc.

System 300 also includes API layer 350. API layer 350 may allow the system to generate summaries across different devices. In some embodiments, API layer 350 may be implemented on user device 322 or user terminal 324. Alternatively, or additionally, API layer 350 may reside on one or more of cloud components 310. API layer 350 (which may be a REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer where microservices reside. In this kind of architecture, the role of the API layer 350 may provide integration between front-end layer and back-end layer. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protections, and API layer 350 may use RESTful APIs as standard for external integration.

FIG. 4 shows illustrative pseudocode for integrated feature graphs, in accordance with one or more embodiments. For example, pseudocode 400 comprises multiple examples of feature transformer data that describe, in a human-readable format, a transformation of the native data at the structure node. Each structure node in an integrated structure may perform one or more transformations on native data. The transformations that occur may depend on the transformations, parameters, and/or sources identified by the feature transformer data.

For example, feature transformer data 402 may comprise code that describes one or more transformations of native data (e.g., data received by a structure node corresponding to feature transformer data 402). Feature transformer data 402 may comprise a log transform, a scaling operation, and/or a normalization/standardization of native data. For example, after a scaling operation, the continuous features become similar in terms of range. Distance-based algorithms like k-NN and k-Means require scaled continuous features as model input. Similarly, standardization (also known as z-score normalization) is the process of scaling values while accounting for standard deviation. If the standard deviation of features differs, the range of those features will likewise differ. The effect of outliers in the characteristics is reduced as a result. To arrive at a distribution with a 0 mean and 1 variance, all the data points are subtracted by their mean and the result divided by the distribution's variance.

In contrast, feature transformer data 404 may comprise code that describes one or more transformations of native data (e.g., data received by a structure node corresponding to feature transformer data 404). Feature transformer data 404 may comprise one-hot encoding. A one-hot encoding is a type of encoding in which an element of a finite set is represented by the index in that set, where only one element has its index set to “1” and all other elements are assigned indices within the range [0, n−1]. In contrast to binary encoding schemes, where each bit can represent 2 values (e.g., 0 and 1), this scheme assigns a unique value for each possible case.

In some embodiments, the values, parameters, and/or other data corresponding to the feature transformer data may be selected and/or generated as an output of an artificial intelligence model (e.g., model 302 (FIG. 3)). For example, as described above, feature engineering (and/or training a model therefor) may comprise selecting and transforming variables when creating a predictive model using machine learning or statistical modeling. In particular, the system may generate feature transformation data that optimizes the feature creation, feature transformation, feature extraction, and feature selection. With deep learning, the feature engineering is automated as part of the algorithm learning.

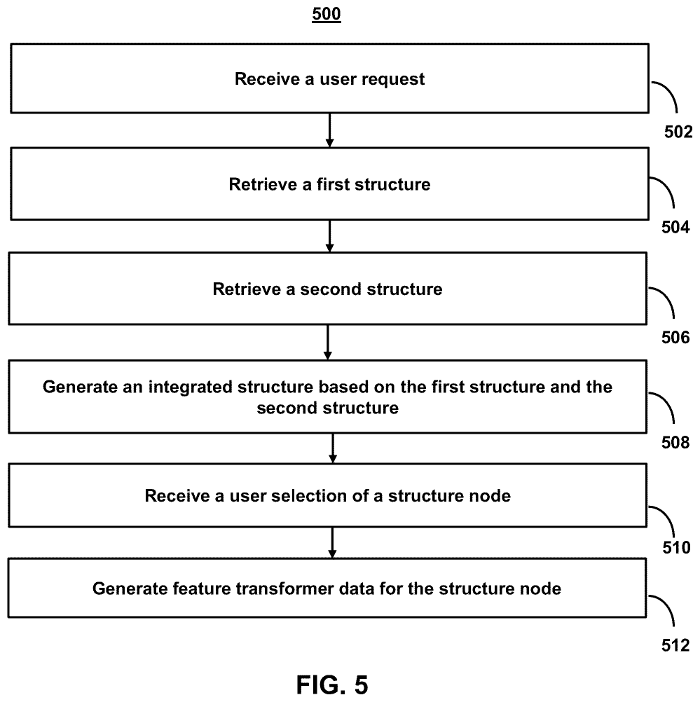

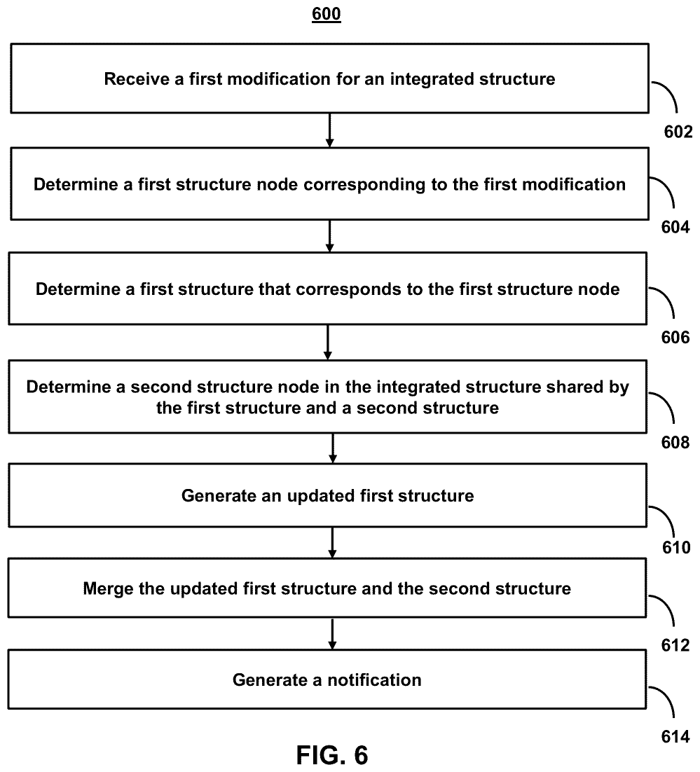

FIG. 5 shows a flowchart of the steps involved in generating integrated feature graphs, in accordance with one or more embodiments. For example, process 500 may represent the steps taken by one or more devices as shown in FIG. 3 when integrating disparate feature groups during feature engineering of training data for artificial intelligence models. In some embodiments, process 500 may be combined with one or more steps of process 600 (FIG. 6). For example, process 500 may relate to an integrated feature graph for a feature engineering pipeline management system that may store native data corresponding to fields of first feature groups (or other non-integrated systems) and feature transformer data (e.g., viewable through a user interface). The feature transformer data may describe a relationship of the native data to the integrated feature graph for a feature engineering pipeline management system, at a structure node in the architecture of the integrated feature graph for a feature engineering pipeline management system. The structure node may correspond to the convergence of two structures in the architecture of the integrated feature graph for a feature engineering pipeline management system. Each structure may itself correspond to a native linear relationship in a second feature group.

For example, the integrated structure may comprise a graphical relationship describing a linear relationship of the first feature lineage and the second feature lineage. The graphical relationship may comprise one or more nodes that represent a feature in a certain frame and an edge between two nodes represents a positive correspondence between the two features. In some embodiments, the system may detect the correspondence to determine a location for each node. For example, the system may generate the integrated structure based on the first structure and the second structure determining a location of the structure node in the integrated structure.

At step 502, process 500 receives (e.g., using control circuitry of one or more components of system 300 (FIG. 3)) a user request to generate an integrated structure for an integrated feature graph for a feature engineering pipeline management system. For example, the system may receive (e.g., via a user interface) a user request to generate an integrated structure for an integrated feature graph for a feature engineering pipeline management system, wherein the integrated structure defines integrated feature lineages in the integrated feature graph. For example, the system may receive a user query to view information about the progress of a feature engineering transformation in a project related to the integrated feature graph for a feature engineering pipeline management system. For example, the system may receive a user query for the integrated feature graph for a feature engineering pipeline management system, determine that a response to the user query is based on a feature engineering transformation in a first lineage, retrieve native data and feature engineering transformation data for the feature engineering transformation, and generate for display the response based on the native data and the feature engineering transformation data.

In some embodiments, the system may receive user updates to a first structure. In response, the system may generate an updated first structure. The system may generate a new integrated structure based on the updated first structure and store the new integrated structure. Furthermore, in some embodiments, generating a new integrated structure based on the updated first structure further comprises the system determining a new structure node shared by the updated first structure and the second structure and generating the new integrated structure by merging the updated first structure and the second structure at the new structure node.

At step 504, process 500 retrieves (e.g., using control circuitry of one or more components of system 300 (FIG. 3)) a first structure for a first feature group. For example, the system may retrieve, a first structure, wherein the first structure defines a first feature lineage for the first feature group. In some embodiments, the first data structure may comprise a data organization, management, and storage format that enables efficient access and modification for the first feature group. For example, the first data structure may include a collection of nodes and edges, data values, data fields, the relationships among them, and the functions or operations that can be applied to the data.

At step 506, process 500 retrieves (e.g., using control circuitry of one or more components of system 300 (FIG. 3)) a second structure. For example, the system may retrieve a second structure, wherein the second structure defines a second feature lineage for the second feature group. In some embodiments, the second data structure may comprise a data organization, management, and storage format that enables efficient access and modification for the second feature group. For example, the second data structure may include a collection of nodes and edges, data values, data fields, the relationships among them, and the functions or operations that can be applied to the data.

At step 508, process 500 generates (e.g., using control circuitry of one or more components of system 300 (FIG. 3)) the integrated structure based on the first structure and the second structure. For example, the system may generate the integrated structure based on the first structure and the second structure, wherein the integrated structure includes a structure node shared by the first structure and the second structure. In some embodiments, generating the integrated structure based on the first structure and the second structure may comprise retrieving a structure graph for the integrated structure. For example, the structure graph may indicate a location of the structure node in the integrated structure.

In some embodiments, the system may retrieve structures from remote locations. For example, the system may, in response to receiving the user request to generate the integrated structure, determine that the integrated structure comprises the first structure and the second structure. The system may, in response to determining that the integrated structure comprises the first structure and the second structure, access: a first remote issue link to a first server housing the first structure; and a second remote issue link to a second server housing the first structure. For example, each remote link may comprise a different cloud resource to access a structure.

At step 510, process 500 receives (e.g., using control circuitry of one or more components of system 300 (FIG. 3)) a user selection of the structure node. For example, the system may receive (e.g., via user interface), a user selection of the structure node. For example, the structure node (e.g., structure node 104 (FIG. 1)) may be a basic unit of a data structure, such as a link between one or more structures. Each structure node may contain data and also may link to other nodes. For example, the integrated structure may be represented by a linear data structure of nodes and edges. In some embodiments, the system may implement links between nodes through pointers.

At step 512, process 500 generates (e.g., using control circuitry of one or more components of system 300 (FIG. 3)) native data, for the first structure or the second structure, and feature transformer data that describes a transformation of the native data at the structure node. For example, the system may generate for display (e.g., on user interface), native data, for the first structure or the second structure, and feature transformer data that describes, in a human-readable format, a transformation of the native data at the structure node.

In some embodiments, the system may receive a first user request corresponding to an engineered feature. The system may, in response to the first user request, generate for display, on the user interface, a first result to the first user request, wherein the first result describes, in the human-readable format, whether the engineered feature is an output of a feature lineage in the integrated structure. Additionally or alternatively, the system may receive a second user request corresponding to a feature transformation. The system may, in response to the second user request, generate for display, on the user interface, a second result to the second user request, wherein the second result describes, in the human-readable format, whether the feature transformation corresponds to any feature transformer data in the integrated structure. Additionally or alternatively, the system may receive a third user request corresponding to an engineered feature. The system may, in response to the third user request, generate for display, on the user interface, a third result to the third user request, wherein the third result describes, in the human-readable format, whether the engineered feature corresponds to the first feature lineage or the second feature lineage.

In some embodiments, the native data for the first structure or the second structure may describe a current progress of a feature engineering transformation in the first feature lineage or the second feature lineage. Additionally or alternatively, the native data for the first structure or the second structure may describe a source of a field value for a feature engineering transformation in the first feature lineage or the second feature lineage. For example, native data may comprise, or native data-formats may comprise, data that originates from and/or relates to the first feature group, the second feature group, or a respective plugin designed therefor. In some embodiments, native data may include data resulting from native code, which is code written specifically for the first feature group, the second feature group, or a respective plugin designed therefor.

For example, the feature transformer data may be presented in any format and/or representation of data that can be naturally read by humans (e.g., via a user interface). In some embodiments, the feature transformer data may appear as a graphical representation of data. For example, the feature transformer data may comprise a knowledge graph of the integrated structure (e.g., graph 100 (FIG. 1)). In such cases, generating the knowledge graph may comprise determining a plurality of structure nodes for the integrated structure and graphically representing a relationship of the plurality of structure nodes (e.g., as shown in FIG. 1). In some embodiments, the integrated structure may comprise a graphical relationship describing a linear relationship of the first feature lineage and the second feature lineage (e.g., as shown in FIGS. 1 and 2).

In some embodiments, the system may allow a user to update the feature transformer data. For example, the system may receive a user update to the feature transformer data and then store the updated feature transformer data. The system may then generate for display the updated feature transformer data subsequently. For example, the system may allow users a given authorization to update feature transformer data subject to that authorization. In such cases, the feature transformer data may have read/write privileges. Upon generating the feature transformer data for display, the system may verify that a current user has one or more read/write privileges. Upon verifying the level of privileges, the system may grant the user access to update the feature transformer data.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1-4 could be used to perform one or more of the steps in FIG. 5.

FIG. 6 shows a flowchart of the steps involved in integrating disparate feature groups during feature engineering of training data for artificial intelligence models, in accordance with one or more embodiments. For example, process 500 may represent the steps taken by one or more devices as shown in FIG. 3 when integrating disparate feature groups during feature engineering of training data for artificial intelligence models. In some embodiments, process 600 may be combined with one or more steps of process 500 (FIG. 5). For example, process 600 may relate to an integrated feature graph for a feature engineering pipeline management system that may store native data corresponding to fields of first feature groups (or other non-integrated systems) and feature transformer data (e.g., viewable through a user interface). The feature transformer data may describe a relationship of the native data to the integrated feature graph for a feature engineering pipeline management system, at a structure node in the architecture of the integrated feature graph for a feature engineering pipeline management system. The structure node may correspond to the convergence of two structures in the architecture of the integrated feature graph for a feature engineering pipeline management system. Each structure may itself correspond to a native linear relationship in a second feature group.

At step 602, process 600 receives (e.g., using control circuitry of one or more components of system 300 (FIG. 3)) a first modification for an integrated structure. For example, the system may receive, via a user interface, a user request for a first modification for an integrated structure for an integrated feature graph for a feature engineering pipeline management system, wherein the integrated structure defines integrated feature lineages in the integrated feature graph. In some embodiments, the integrated feature graph may comprise a knowledge graph of the integrated structure, and wherein generating the knowledge graph comprises determining a plurality of structure nodes for the integrated structure and graphically representing a relationship of the plurality of structure nodes.

In some embodiments, the modification may comprise a modification to feature transformer data. For example, the system may receive a first user update to feature transformer data, wherein the feature transformer data describes, in a human-readable format, a transformation of native data at a current structure node in the integrated structure. The system may then generate updated feature transformer data and store the updated feature transformer data. In some embodiments, the modification may comprise a modification to a current structure. For example, the system may receive a second user update to a current structure in the integrated structure. The system may generate the first structure by updating the current structure.

At step 604, process 600 determines (e.g., using control circuitry of one or more components of system 300 (FIG. 3)) a first structure node corresponding to the first modification. For example, the system may determine a first structure node in the integrated structure corresponding to the first modification. To do so, the system may determine feature transformer data affected by the modification and determine a structure node corresponding to the feature transformer data. For example, the system may determine an engineered feature corresponding to the first modification. The system may determine that the engineered feature corresponds to the first feature lineage. The system may then select the first structure from a plurality of structures in the integrated structure based on determining that the engineered feature corresponds to the first feature lineage.

In some embodiments, the system may determine feature transformer data affected by the modification and determine a structure node corresponding to the feature transformer data. The system may do this by iteratively searching for and/or analyzing feature transformer data for each node in the integrated structure. For example, the system may determine a plurality of nodes in the first structure. The system may then determine whether each of the plurality of nodes is shared with another structure in the integrated structure. By doing so, the system not only determines what node is affected, but also what other nodes are affected downstream.

At step 606, process 600 determines (e.g., using control circuitry of one or more components of system 300 (FIG. 3)) a first structure that corresponds to the first structure node. For example, the system may determine a first structure that corresponds to the first structure node, wherein the first structure defines a first feature lineage.

At step 608, process 600 determines (e.g., using control circuitry of one or more components of system 300 (FIG. 3)) a second structure node in the integrated structure shared by the first structure and a second structure. For example, the system may determine a second structure node in the integrated structure shared by the first structure and a second structure, wherein the second structure defines a second feature lineage.

At step 610, process 600 generates (e.g., using control circuitry of one or more components of system 300 (FIG. 3)) an updated first structure. For example, the system may generate an updated first structure based on the first modification. To generate the updated structure the system may modify the feature lineage and/or feature transformer data corresponding to a node. For example, the system may receive an updated feature engineering transformation for a current structure node in the first feature lineage. The system may replace a current feature engineering transformation for the current structure node in the first feature lineage with the updated feature engineering transformation.

At step 612, process 600 merges (e.g., using control circuitry of one or more components of system 300 (FIG. 3)) the updated first structure and the second structure. For example, the system may merge the updated first structure and the second structure at the second structure node to generate an updated integrated structure.

In some embodiments, the system may merge the structures at multiple nodes. For example, the system may determine a plurality of shared nodes and/or nodes affected by a modification. For example, the system may determine a third structure node in the integrated structure, wherein the third structure node is shared by the first structure and a third structure, wherein the third structure defines a third feature lineage. The system may then merge the updated first structure and the third structure at the third structure node to generate the updated integrated structure. In another example, the system may receive an updated structure node for the first feature lineage. The system may then replace a current structure node in the first feature lineage with the updated structure node. In yet another example, the system may receive an updated feature transformer data for a current structure node in the first feature lineage. The system may replace current feature transformer data for the current structure node in the first feature lineage with the updated feature transformer data.

At step 614, process 600 generates (e.g., using control circuitry of one or more components of system 300 (FIG. 3)) a notification. For example, the system may, in response to generating an updated integrated structure, generate for display, on the user interface, a notification corresponding to the updated integrated structure. In some embodiments, the notification may comprise a confirmation that an update is complete. Alternatively or additionally, the system may indicate other information and/or other options. Such options may include options to review information about a node, feature lineage, etc. For example, the system may receive, via the user interface, a user selection of the current structure node. The system may, in response to the user selection of the current structure node, generate for display, on the user interface, native data, for the updated first structure, and the updated feature transformer data that describes, in a human-readable format, a transformation of the native data at the current structure node.

In some embodiments, the options may include options to validate an update. For example, the system may validate feature lineages in the updated integrated structure. The system may select the notification from a plurality of notifications based on validating the feature lineages. By doing so, the system may confirm that the merge was successful and no lineages were broken.

Alternatively or additionally, the system may allow the user to search and/or perform other functions related to the updated integrated structure. For example, the system may receive a first user request corresponding to an engineered feature. The system may, in response to the first user request, generate for display, on the user interface, a first result to the first user request, wherein the first result describes, in a human-readable format, whether the engineered feature is an output of a feature lineage in the updated integrated structure. In another example, the system may receive a second user request corresponding to a feature transformation. The system may, in response to the second user request, generate for display, on the user interface, a second result to the second user request, wherein the second result describes, in a human-readable format, whether the feature transformation corresponds to any feature transformer data in the updated integrated structure. In yet another example, the system may receive a third user request corresponding to an engineered feature. The system may, in response to the third user request, generate for display, on the user interface, a third result to the third user request, wherein the third result describes, in a human-readable format, whether the engineered feature corresponds to the first feature lineage or the second feature lineage.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods.

The present techniques will be better understood with reference to the following enumerated embodiments:

1. A method for generating integrated feature graphs during feature engineering of training data for artificial intelligence models.
2. The method of any one of the preceding embodiments, further comprising: receiving, via a user interface, a user request to generate an integrated structure for an integrated feature graph for a feature engineering pipeline management system, wherein the integrated structure defines integrated feature lineages in the integrated feature graph; retrieving, from a feature engineering knowledge database, a first structure, wherein the first structure defines a first feature lineage; retrieving, from the feature engineering knowledge database, a second structure, wherein the second structure defines a second feature lineage; generating the integrated structure based on the first structure and the second structure, wherein the integrated structure includes a structure node shared by the first structure and the second structure; receiving, via the user interface, a user selection of the structure node; and in response to the user selection of the structure node, generating for display, on the user interface, native data, for the first structure or the second structure, and feature transformer data that describes, in a human-readable format, a transformation of the native data at the structure node.
3. The method of any one of the preceding embodiments, further comprising: receiving a first user request corresponding to an engineered feature; and in response to the first user request, generating for display, on the user interface, a first result to the first user request, wherein the first result describes, in the human-readable format, whether the engineered feature is an output of a feature lineage in the integrated structure.
4. The method of any one of the preceding embodiments, further comprising: receiving a second user request corresponding to a feature transformation; and in response to the second user request, generating for display, on the user interface, a second result to the second user request, wherein the second result describes, in the human-readable format, whether the feature transformation corresponds to any feature transformer data in the integrated structure.
5. The method of any one of the preceding embodiments, further comprising: receiving a third user request corresponding to an engineered feature; and in response to the third user request, generating for display, on the user interface, a third result to the third user request, wherein the third result describes, in the human-readable format, whether the engineered feature corresponds to the first feature lineage or the second feature lineage.
6. The method of any one of the preceding embodiments, wherein the native data for the first structure or the second structure describes a current progress of a feature engineering transformation in the first feature lineage or the second feature lineage.
7. The method of any one of the preceding embodiments, wherein the native data for the first structure or the second structure describes a source of a field value for a feature engineering transformation in the first feature lineage or the second feature lineage.
8. The method of any one of the preceding embodiments, wherein the integrated structure comprises a graphical relationship describing a linear relationship of the first feature lineage and the second feature lineage.
9. The method of any one of the preceding embodiments, wherein generating the integrated structure based on the first structure and the second structure comprises determining a location of the structure node in the integrated structure.
10. The method of any one of the preceding embodiments, further comprising: in response to receiving the user request to generate the integrated structure, determining that the integrated structure comprises the first structure and the second structure; and in response to determining that the integrated structure comprises the first structure and the second structure, accessing: a first remote issue link to a first server housing the first structure; and a second remote issue link to a second server housing the first structure.
11. The method of any one of the preceding embodiments, further comprising: determining a first feature type for the first feature lineage; determining a second feature type for the second feature lineage; and determining a rule set for automatically generating the integrated structure based on the first feature type and the second feature type.
12. The method of any one of the preceding embodiments, wherein the integrated feature graph comprises a knowledge graph of the integrated structure, and wherein generating the knowledge graph comprises determining a plurality of structure nodes for the integrated structure and graphically representing a relationship of the plurality of structure nodes.
13. The method of any one of the preceding embodiments, further comprising: receiving a first user update to the feature transformer data; generating updated feature transformer data; and storing the updated feature transformer data.
14. The method of any one of the preceding embodiments, further comprising: receiving a second user update to the first structure; generating an updated first structure; generating a new integrated structure based on the updated first structure; and storing the new integrated structure.
15. The method of any one of the preceding embodiments, wherein generating a new integrated structure based on the updated first structure further comprises: determining a new structure node shared by the updated first structure and the second structure; and generating the new integrated structure by merging the updated first structure and the second structure at the new structure node.
16. A method for integrating disparate feature groups during feature engineering of training data for artificial intelligence models.
17. The method of any one of the preceding embodiments, further comprising: receiving, via a user interface, a user request for a first modification for an integrated structure for an integrated feature graph for a feature engineering pipeline management system, wherein the integrated structure defines integrated feature lineages in the integrated feature graph; determining a first structure node in the integrated structure corresponding to the first modification; determining a first structure that corresponds to the first structure node, wherein the first structure defines a first feature lineage; determining a second structure node in the integrated structure, wherein the second structure node is shared by the first structure and a second structure, wherein the second structure defines a second feature lineage; generating an updated first structure based on the first modification; merging the updated first structure and the second structure at the second structure node to generate an updated integrated structure; and in response to generating an updated integrated structure, generating for display, on the user interface, a notification corresponding to the updated integrated structure.
18. The method of any one of the preceding embodiments, wherein determining the first structure node in the integrated structure corresponding to the first modification comprises: determining an engineered feature corresponding to the first modification; determining that the engineered feature corresponds to the first feature lineage; and selecting the first structure from a plurality of structures in the integrated structure based on determining that the engineered feature corresponds to the first feature lineage.
19. The method of any one of the preceding embodiments, wherein determining the first structure node in the integrated structure corresponding to the first modification comprises: determining a plurality of nodes in the first structure; and determining whether each of the plurality of nodes is shared with another structure in the integrated structure.
20. The method of any one of the preceding embodiments, further comprising:
determining a third structure node in the integrated structure, wherein the third structure node is shared by the first structure and a third structure, wherein the third structure defines a third feature lineage; and merging the updated first structure and the third structure at the third structure node to generate the updated integrated structure.
   21. The method of any one of the preceding embodiments, wherein generating the updated first structure based on the first modification further comprises: receiving an updated feature engineering transformation for a current structure node in the first feature lineage; and replacing a current feature engineering transformation for the current structure node in the first feature lineage with the updated feature engineering transformation.
   22. The method of any one of the preceding embodiments, wherein generating the updated first structure based on the first modification further comprises: receiving an updated structure node for the first feature lineage; and replacing a current structure node in the first feature lineage with the updated structure node.
   23. The method of any one of the preceding embodiments, wherein generating the updated first structure based on the first modification further comprises: receiving an updated feature transformer data for a current structure node in the first feature lineage; and replacing current feature transformer data for the current structure node in the first feature lineage with the updated feature transformer data.
   24. The method of any one of the preceding embodiments, further comprising: receiving, via the user interface, a user selection of the current structure node; and in response to the user selection of the current structure node, generating for display, on the user interface, native data, for the updated first structure, and the updated feature transformer data that describes, in a human-readable format, a transformation of the native data at the current structure node.
   25. The method of any one of the preceding embodiments, further comprising:
validating feature lineages in the updated integrated structure; and selecting the notification from a plurality of notifications based on validating the feature lineages.
   26. The method of any one of the preceding embodiments, further comprising: receiving a first user request corresponding to an engineered feature; and in response to the first user request, generating for display, on the user interface, a first result to the first user request, wherein the first result describes, in a human-readable format, whether the engineered feature is an output of a feature lineage in the updated integrated structure.
   27. The method of any one of the preceding embodiments, further comprising: receiving a second user request corresponding to a feature transformation; and in response to the second user request, generating for display, on the user interface, a second result to the second user request, wherein the second result describes, in a human-readable format, whether the feature transformation corresponds to any feature transformer data in the updated integrated structure.
   28. The method of any one of the preceding embodiments, further comprising: receiving a third user request corresponding to an engineered feature; and in response to the third user request, generating for display, on the user interface, a third result to the third user request, wherein the third result describes, in a human-readable format, whether the engineered feature corresponds to the first feature lineage or the second feature lineage.
   29. The method of any one of the preceding embodiments, wherein the integrated feature graph comprises a knowledge graph of the integrated structure, and wherein generating the knowledge graph comprises determining a plurality of structure nodes for the integrated structure and graphically representing a relationship of the plurality of structure nodes.
   30. The method of any one of the preceding embodiments, wherein receiving the user request for the first modification comprises: receiving a first user update to feature transformer data, wherein the feature transformer data describes, in a human-readable format, a transformation of native data at a current structure node in the integrated structure; generating updated feature transformer data; and storing the updated feature transformer data.
   31. The method of any one of the preceding embodiments, wherein receiving the user request for the first modification comprises: receiving a second user update to a current structure in the integrated structure; and generating the first structure by updating the current structure.
   32. A tangible, non-transitory, machine-readable medium storing instructions that, when executed by a data processing apparatus, cause the data processing apparatus to perform operations comprising those of any of embodiments 1-30.
   33. A system comprising one or more processors; and memory storing instructions that, when executed by the processors, cause the processors to effectuate operations comprising those of any of embodiments 1-30.
   34. A system comprising means for performing any of embodiments 1-30.

What is claimed is:

1. A system for integrating disparate feature groups during feature engineering of training data for artificial intelligence models, comprising:
one or more processors; and
a non-transitory computer readable medium comprising instructions that when executed by the one or more processors causes operations comprising:
receiving, via a user interface, a user request for a first modification for an integrated structure for an integrated feature graph for a feature engineering pipeline management system, wherein the integrated structure defines integrated feature lineages in the integrated feature graph, wherein the integrated feature lineages comprise a plurality of nodes and a linear relationships between the plurality of nodes, and wherein a respective node of the plurality of nodes corresponds to a respective data engineering transformation occurring at the respective node;
determining a first structure node in the integrated structure corresponding to the first modification;
retrieving, from a feature engineering knowledge database, a first structure for a first feature group, wherein the first structure defines a first feature lineage for the first feature group;
determining that the first structure that corresponds to the first structure node;
determining a second structure node in the integrated structure, wherein the second structure node is shared by the first structure and a second structure, wherein the second structure defines a second feature lineage;
generating an updated first structure based on the first modification;
merging the updated first structure and the second structure at the second structure node to generate an updated integrated structure; and
in response to generating an updated integrated structure, generating for display, on the user interface, a notification corresponding to the updated integrated structure.

2. A method for integrating disparate feature groups during feature engineering of training data for artificial intelligence models, comprising:
receiving, via a user interface, a user request for a first modification for an integrated structure for an integrated feature graph for a feature engineering pipeline management system, wherein the integrated structure defines integrated feature lineages in the integrated feature graph;
determining a first structure node in the integrated structure corresponding to the first modification;
determining a first structure that corresponds to the first structure node, wherein the first structure defines a first feature lineage;
determining a second structure node in the integrated structure shared by the first structure and a second structure, wherein the second structure defines a second feature lineage;
generating an updated first structure based on the first modification;
merging the updated first structure and the second structure at the second structure node to generate an updated integrated structure; and
in response to generating an updated integrated structure, generating for display, on the user interface, a notification corresponding to the updated integrated structure.

3. The method of claim 2, wherein determining the first structure node in the integrated structure corresponding to the first modification comprises:
determining an engineered feature corresponding to the first modification;
determining that the engineered feature corresponds to the first feature lineage; and
selecting the first structure from a plurality of structures in the integrated structure based on determining that the engineered feature corresponds to the first feature lineage.

4. The method of claim 2, wherein determining the first structure node in the integrated structure corresponding to the first modification comprises:
determining a plurality of nodes in the first structure; and
determining whether each of the plurality of nodes is shared with another structure in the integrated structure.

5. The method of claim 2, further comprising:
determining a third structure node in the integrated structure, wherein the third structure node is shared by the first structure and a third structure, wherein the third structure defines a third feature lineage; and
merging the updated first structure and the third structure at the third structure node to generate the updated integrated structure.

6. The method of claim 2, wherein generating the updated first structure based on the first modification further comprises:
receiving an updated feature engineering transformation for a current structure node in the first feature lineage; and
replacing a current feature engineering transformation for the current structure node in the first feature lineage with the updated feature engineering transformation.

7. The method of claim 2, wherein generating the updated first structure based on the first modification further comprises:
receiving an updated structure node for the first feature lineage; and
replacing a current structure node in the first feature lineage with the updated structure node.

8. The method of claim 2, wherein generating the updated first structure based on the first modification further comprises:
receiving an updated feature transformer data for a current structure node in the first feature lineage; and
replacing current feature transformer data for the current structure node in the first feature lineage with the updated feature transformer data.

9. The method of claim 8, further comprising:
receiving, via the user interface, a user selection of the current structure node; and
in response to the user selection of the current structure node, generating for display, on the user interface, native data, for the updated first structure, and the updated feature transformer data that describes, in a human-readable format, a transformation of the native data at the current structure node.

10. The method of claim 2, further comprising:
validating feature lineages in the updated integrated structure; and
selecting the notification from a plurality of notifications based on validating the feature lineages.

11. The method of claim 2, further comprising:
receiving a first user request corresponding to an engineered feature; and
in response to the first user request, generating for display, on the user interface, a first result to the first user request, wherein the first result describes, in a human-readable format, whether the engineered feature is an output of a feature lineage in the updated integrated structure.

12. The method of claim 2, further comprising:
receiving a second user request corresponding to a feature transformation; and
in response to the second user request, generating for display, on the user interface, a second result to the second user request, wherein the second result describes, in a human-readable format, whether the feature transformation corresponds to any feature transformer data in the updated integrated structure.

13. The method of claim 2, further comprising:
receiving a third user request corresponding to an engineered feature; and
in response to the third user request, generating for display, on the user interface, a third result to the third user request, wherein the third result describes, in a human-readable format, whether the engineered feature corresponds to the first feature lineage or the second feature lineage.

14. The method of claim 2, wherein the integrated feature graph comprises a knowledge graph of the integrated structure, and wherein generating the knowledge graph comprises determining a plurality of structure nodes for the integrated structure and graphically representing a relationship of the plurality of structure nodes.

15. The method of claim 2, wherein receiving the user request for the first modification comprises:
receiving a first user update to feature transformer data, wherein the feature transformer data describes, in a human-readable format, a transformation of native data at a current structure node in the integrated structure;
generating updated feature transformer data; and
storing the updated feature transformer data.

16. The method of claim 2, wherein receiving the user request for the first modification comprises:
receiving a second user update to a current structure in the integrated structure; and
generating the first structure by updating the current structure.

17. A non-transitory, computer-readable medium comprising instructions that, when executed by one or more processors, cause operations comprising:
receiving, via a user interface, a user request for a first modification for an integrated structure for an integrated feature graph for a feature engineering pipeline management system, wherein the integrated structure defines integrated feature lineages in the integrated feature graph;
determining a first structure node in the integrated structure corresponding to the first modification;
determining a first structure that corresponds to the first structure node, wherein the first structure defines a first feature lineage;
determining a second structure node in the integrated structure, wherein the second structure node is shared by the first structure and a second structure, wherein the second structure defines a second feature lineage;
generating an updated first structure based on the first modification;
merging the updated first structure and the second structure at the second structure node to generate an updated integrated structure; and
in response to generating an updated integrated structure, generating for display, on the user interface, a notification corresponding to the updated integrated structure.

18. The non-transitory, computer-readable medium of claim 17, wherein determining the first structure node in the integrated structure corresponding to the first modification comprises:
determining an engineered feature corresponding to the first modification;
determining that the engineered feature corresponds to the first feature lineage; and
selecting the first structure from a plurality of structures in the integrated structure based on determining that the engineered feature corresponds to the first feature lineage.

19. The non-transitory, computer-readable medium of claim 17, wherein determining the first structure node in the integrated structure corresponding to the first modification comprises:
determining a plurality of nodes in the first structure; and
determining whether each of the plurality of nodes is shared with another structure in the integrated structure.

20. The non-transitory, computer-readable medium of claim 17, further comprising:
determining a third structure node in the integrated structure, wherein the third structure node is shared by the first structure and a third structure, wherein the third structure defines a third feature lineage; and
merging the updated first structure and the third structure at the third structure node to generate the updated integrated structure.
